(19) United States
(12) Patent Application Publication
(10) Pub. No.: US 2019/0336802 A1
(43) Pub. Date: Nov. 7, 2019

(54) PORTABLE WATER SPRAYING DEVICE

(71) Applicant: GARY BROWN, Amstrong, IA (US)

(72) Inventor: GARY BROWN, Amstrong, IA (US)

(21) Appl. No.: 16/400,238

(22) Filed: May 1, 2019

Related U.S. Application Data
(60) Provisional application No. 62/665,184, filed on May 1, 2018.

(51) Int. Cl. A62C 31/03; A62C 31/24; A62C 31/28; B66F 9/075

(52) U.S. Cl. CPC A62C 31/03; A62C 31/24; B05B 3/18; B66F 9/07504; A62C 31/28

(57) ABSTRACT

A water spraying attachment for an adjustable height vehicle including a housing having a water attachment connection disposed at a rear portion and a spray aperture on a front wall of the housing, a water inlet, and a spray assembly having a pipe connected to the water inlet and having a sprayer outlet, a flexible sprayer hose fluidly coupled to the sprayer outlet, and a nozzle with a first end fluidly coupled to the flexible sprayer hose and a second end pointed out the spray aperture. The device has a spray movement assembly operably attached to the spray assembly, the spray movement assembly having a sprayer frame attached to the spray assembly and a movement device operably coupled to the sprayer frame.

### CROSS-REFERENCE TO RELATED APPLICATION(S)

This application claims priority to U.S. Provisional Patent Application No. 62/665,184, filed on May 1, 2018, entitled “PORTABLE WATER SPRAYING DEVICE,” the disclosure of which is hereby incorporated herein by reference in its entirety.

### BACKGROUND OF THE DISCLOSURE

In certain areas, access to fully equipped fire trucks, such as a ladder truck, capable of hauling their own water supplies or attaching to existing supplies of water may not be available. This may be for any number of reasons such as municipal budget issues, terrain issues, or many other reasons. There is a need for an inexpensive device that may be attached to readily available vehicles/implements such as a telehandler, wheel loader, skid loader, fork lift, or any other lifting machine equipped with pallet forks, for the purpose of spraying fire suppressing water to areas that may be unreachable from the ground level.

This type of attachment has an ability to attach to already existing hydraulic controls within the vehicle to control the sprayer in directional and up/down directions. Further, the attachment aids in user fatigue as a fire may take an inordinate amount of time to fully put out, which can be extremely tiring for firefighters. Rural areas depend on the time of volunteers, and in some areas volunteers may be difficult to recruit and maintain. The attachment may allow a single firefighter, working within a confined cab and out of the elements, to control the spray for any amount of time without suffering from fatigue, extreme heat exposure, extreme cold exposure or frostbite. The attachment further increases the safety of the firefighter or user who is no longer forced to hold the end of a charged and powerful hose near a dangerous fire.

### SUMMARY OF THE PRESENT DISCLOSURE

One aspect of the present disclosure includes a water spraying attachment for an adjustable height vehicle including a housing having a water attachment connection disposed at a rear portion and a spray aperture on a front wall of the housing, a water inlet, and a spray assembly having a pipe connected to the water inlet and having a sprayer outlet, a flexible sprayer hose fluidly coupled to the sprayer outlet, and a nozzle with a first end fluidly coupled to the flexible sprayer hose and a second end pointed out the spray aperture. The device has a spray movement assembly operably attached to the spray assembly, the spray movement assembly having a sprayer frame attached to the spray assembly and a movement device operably coupled to the sprayer frame.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is an isometric picture of the water spraying device of an embodiment.

FIG. 2 is a front elevated view of the water spraying device of an embodiment.

FIG. 3 is a closeup of the water attachment of the water spraying device of an embodiment.

FIG. 4 is a view of the interior of the water spraying device of an embodiment.

FIG. 5 is a side view of the interior of the water spraying device of an embodiment.

FIG. 6 is a closeup view of the water movement assembly in one position of the water spraying device of an embodiment.

FIG. 7 is a closeup view of the water movement assembly in a second position of the water spraying device of an embodiment.

FIGS. 8-10 are views of the front of the water spraying device of an embodiment in different spray positions.

FIG. 11 is a view of the securing chains of the water spraying device of an embodiment.

FIG. 12 is a view of the storage of the securing chains and hydraulic lines after use of the water spraying device of an embodiment.

### DETAILED DESCRIPTION OF EMBODIMENTS

It is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

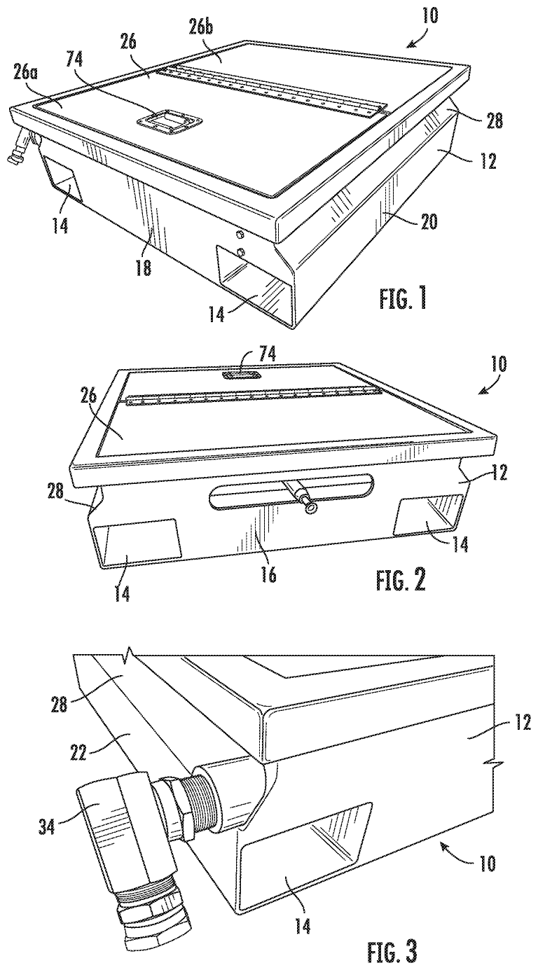

FIGS. 1-2 show a water spraying attachment 10 that may include a housing 12. The housing 12 may be made of a sheet metal, such as aluminum, stainless steel, or any other material that is strong enough to hold the components of the spraying attachment. The housing 12 may include a pair of channels or gussets 14 that allow the device 10 to be installed onto an adjustable height vehicle such as a forklift. The channels or gussets 14 may be sized such that they slidably fit over the forks of a forklift, while preventing excessive side-to-side movement when installed. The housing 12 may also be configured to be attached to any other vehicle that has a height adjustment, such as a telehandler, wheel loader, skid loader, or any other lifting machine equipped with pallet fork.

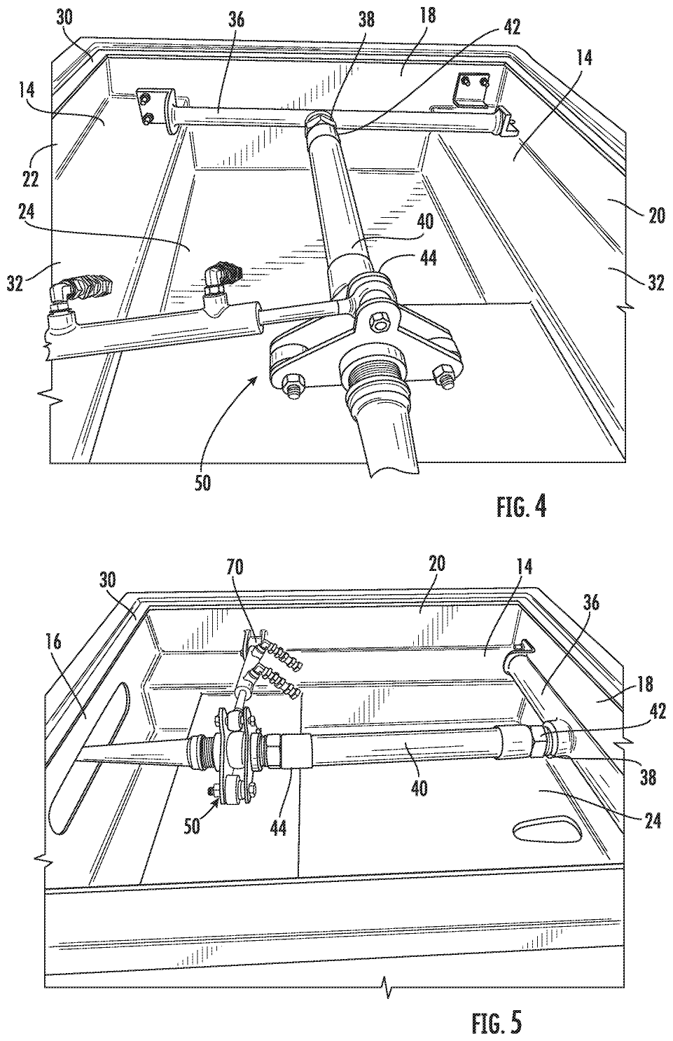

The housing 12 may have a generally rectangular shape, with a front wall 16, back wall 18, right hand side wall 20, left hand side wall 22, bottom wall 24, and a removable top wall 26. The dimensions of the housing may be about 40″ wide, 43″ long, and 12″ high. As shown in FIG. 1, the side walls may include an in-turned portion 28 that reaches in from the top of the gussets 14 toward the middle of the housing 12, providing for some overhang of the top. Additionally, the front wall 16 and the rear wall 18 may be spaced a shorter distance than the overall length. These details allow for a consistent interior dimension to an inner lip 30 of the top (see FIGS. 4-5) if a removable top 26 is added to the device, as is described in detail below. The sides and front may also have an overhang of about 2″ to allow a user or users to grab and easily carry the unit from place to place and load onto a pickup truck, for example.

One or more of the walls may have apertures that allow for the components of the water spraying attachment to function, as is described in more detail below. In an embodiment, at least a portion of the right side wall 20, left side wall 22, and bottom wall 24 are formed by two of the exterior walls of each of the gussets 14. The remaining two exterior walls of each of the gussets 14 may form interior ledges 32 within the housing 12. The interior ledges 32 may form a base for attaching components of the device. The front of the device is generally described as the portion of the device that faces away from the cab of a forklift. The rear of the device is generally described as the portion of the device that faces back toward the cab of the forklift.

As shown in FIG. 3, the device may include a water attachment coupling 34 on one side wall of the housing. This coupling may include specific attachments such that the coupling may attach easily to a standard 2″ water supply, and may be stainless steel. The coupling may have a 90-degree bend that attaches to a water pipe 36 that is generally disposed at a rear portion of the interior of the housing 12, as shown in FIGS. 4-5. The water pipe 36 may extend from one side wall of the housing 12 to the other. Near the middle of the water pipe 36 is a water junction 38 that allows water to be directed toward the front of the housing 12. This junction 38 may be connected to a flexible, 2″ hydraulic hose 40 having a pipe end 42 and a nozzle end 44. The junction 38 may be secured with stainless steel fittings between the hose 40 and the water pipe 36. The flexible hose 40 may reach nearly to the front of the housing 12. In this case the term “nearly to the front of the housing” generally means anywhere from 50 to 90% of the front of the housing 12.

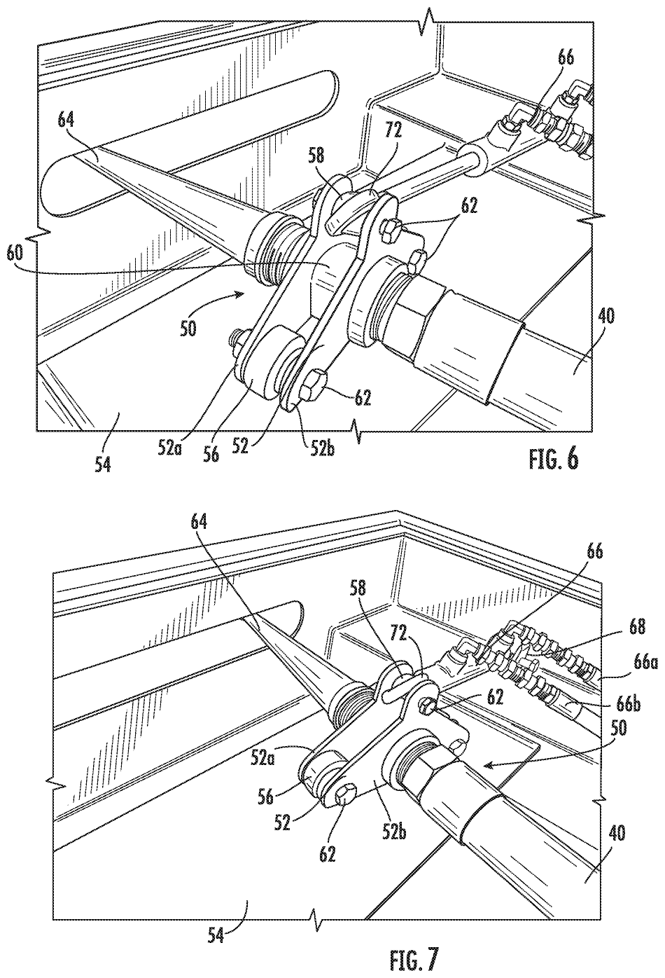

As shown in FIGS. 6-7, the flexible hose nozzle end may be connected to a spray movement assembly 50. The spray movement assembly 50 may have a generally triangular shaped frame 52 that is slidable along a lateral wall 54 within the housing. The frame 52 may be made from a first frame plate 52a and a second frame plate 52b spaced apart by a distance operable to house wheels 56 and a hydraulic cylinder fitting 58 as will be described in more detail below. The frame plates 52a, 52b may be spaced apart by a bushing 60 and held together by a bolt 62. The plates may also be spaced apart and connected in any other way known in the art. The lateral wall 54 may extend from one of the ledges 14 across the interior of the housing to the other ledge 14, substantially on the same plane as the ledges 14. The lateral wall 54 may be attached to the ledges by weld or any other method known in the art.

The frame 52 may be slidable along the lateral wall on the interior of the housing. The slidable movement may be effected through wheels 56 attached between the frame plates. The wheels are rotationally disposed within the frame 52, and ride along a top side of the lateral wall 54. This slidable movement may also be accomplished by fixedly attaching a slidable element, made from a material that slides easily over the material of the lateral wall, to the frame and allowing it to slide on the top portion of the lateral wall. This slidable movement on top of the lateral wall 54, in combination with the flexible hose 40, allows for a certain amount of lateral movement of the water coming from the flexible hose. On the side of the frame 52 opposite the flexible hose there may be a nozzle 64 attached to the frame 52. This nozzle 64 allows water that is coming through the water pipe 36, through the flexible hose 40, and through the frame 52, to exit the device 10 at a desired shape and rate.

The movement of the frame 52, and therefore the nozzle 64 and the direction of the spray water, may be effected by the use of a hydraulic cylinder 66. The hydraulic cylinder 66 may have a fixed end 68 coupled to a bracket 70 on a top side of one of the gussets. The bracket 70 may be a pair of parallel walls or flanges with a pin connected between the walls. The bracket 70 may be attached to the ledge by a weld, or any other attachment means known in the art. The cylinder 66 may have an end 68 that attaches to the pin. The hydraulic cylinder may have a second end 72 coupled to a pin in the frame 52. Both of these connections are fixed positionally with respect to the parts that they're coupled with, but allow for some rotational movement (i.e. the cylinder 66 is fixed positionally with respect to the bracket 70, but is allowed to rotate about the pin; similarly, the cylinder 66 is fixed positionally with respect to the frame 52, but is allowed to rotate about the pin).

Movement of the spray movement assembly 50 is then accomplished by the extension and retraction of the hydraulic cylinder 66 (i.e. even though the cylinder 66 is fixed with respect to the frame 52, the frame is moveable with respect to the housing 12, so the extension and retraction of the cylinder piston 66 moves the frame 52 as well). The hydraulic cylinder 66 may have 2 hydraulic fluid connections 66a, 66b (see FIGS. 6-7), directly or indirectly connected to cab of the forklift or other device hydraulically. This connection allows for the control of the direction of water spray exiting the device from within the cab of the forklift. These attachments may be by any manner known in the art.

A removable top 26 may be added to the device. A lip 30 may be attached to the inside wall of the housing 12 near the top of the housing. “Near the top of the housing” in this respect refers to a distance down from the top that is roughly equal to the thickness of the removable top 26 that may be used. This allows for a uniform and flush top surface of the device with the top 26 attached. The top 26 may be formed from two halves 26a, 26b that are hingedly attached to one another and fit within the outer top lip of the housing 12 and rest on the inner top lip 30. The removable top 26 may also have a handle 74 that allows for easy access to the interior of the housing 12. In this way, the hydraulic lines and a holding or securing chain 76 may exit the interior of the housing 12 while the device is in use. There may also be one or more apertures in the rear wall 18 to allow these parts to exit the interior of the housing. When use of the device 10 is complete, the securing chain or chains 76 and hydraulic lines may be placed within the interior of the housing 12 and the top closed 26 for easy transport in the back of a truck or other method of transport.

In order to use the device 12, the housing may be attached to the forklift by sliding the gussets or channels 14 over the front forks of the forklift. At this time a securing chain 76 may be wrapped around the vertical rails of the fork and tightened, in order to minimize vibration, as well as lateral and fore/aft movement of the device after it is installed. The water coupling 34 may be hooked to a water supply in any manner known in the art. The two hydraulic fluid connections 66a, 66b may also be connected to the forklift allowing the user to manipulate the direction of flow of water exiting the device.

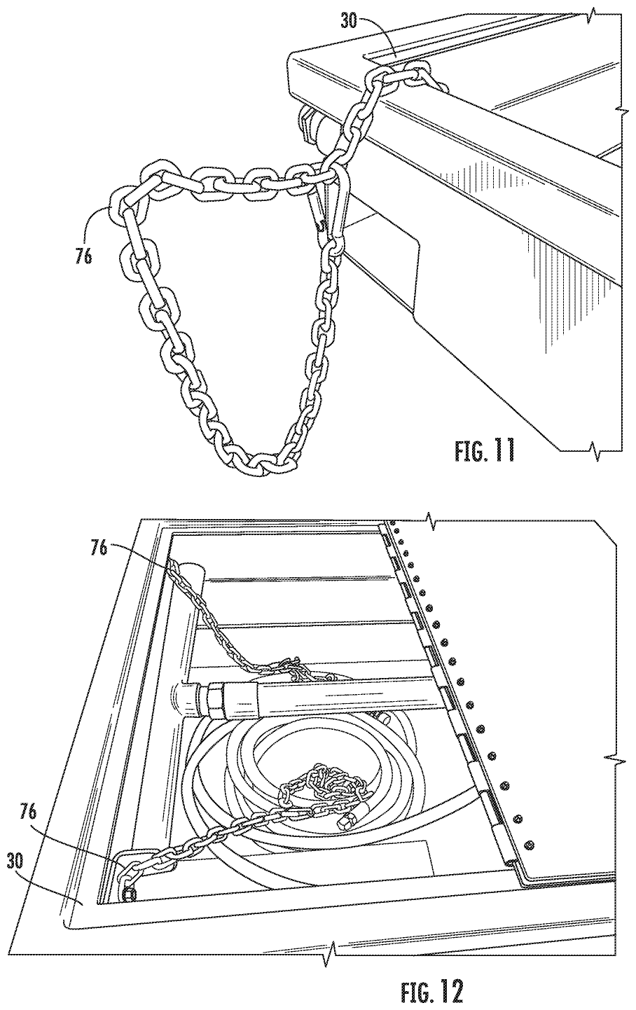

Once the water is hooked up, the securing chain 76, winch, utility straps, or other securing device is attached and tightened, and the hydraulic lines 66a, 66b are connected, the user may manipulate the vehicle and begin spraying the desired location. The forklift may be raised to a height anywhere between 0 feet and the maximum height of the forklift, may be turned in any direction or moved to any position a user desires, and begin spraying. In an embodiment, a securing chain or chains 76 are used. FIG. 12 shows how a pair of chains 76 may be used to secure the device to the forklift.

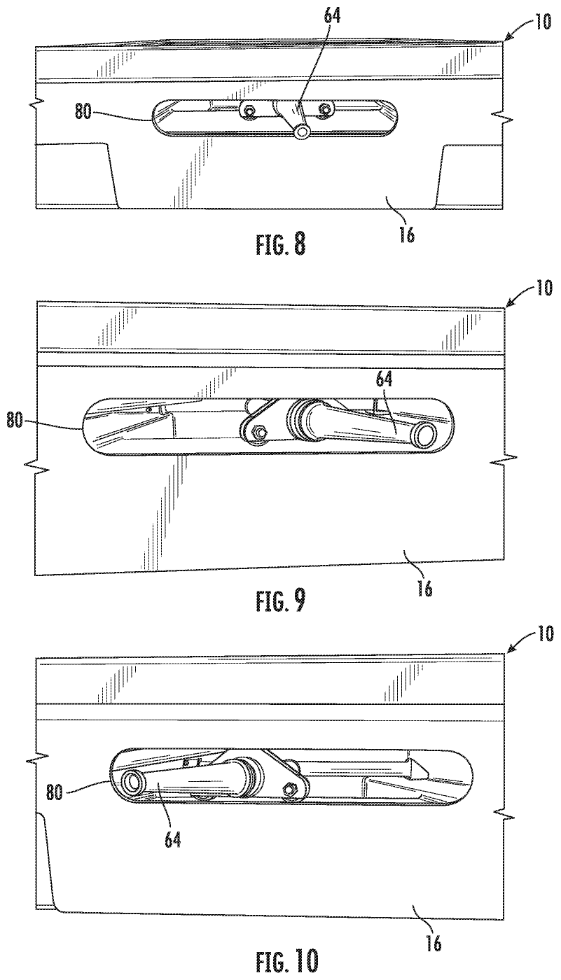

As shown in FIGS. 8-10, the user may have a lever or some other manipulating device within the cab that allows the user to effect movement of the spray movement assembly laterally while not moving the forklift or the forks, keeping the device and the forklift in a stable position. The user pushes or manipulates the lever, pushing hydraulic fluid in a certain direction within the cylinder 66, which pushes the water movement assembly 50 in a certain direction. The nozzle 64 may reach out a spray aperture 80 in the front wall 16 of the device and onto the desired surface. The nozzle may be manipulated through movement of about 30 degrees. There may also be a fluid restrictor (not shown) in place at a point in the hydraulic circuit which prevents excessively quick movement of the nozzle, to prevent swaying caused by the changing vector of the water pressure and maximize the stability of the unit.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A water spraying attachment for an adjustable height vehicle comprising:
a housing having a water attachment connection disposed at a rear portion and a spray aperture on a front wall of the housing;
a water inlet;
a spray assembly, comprising:
a pipe connected to the water inlet and having a sprayer outlet;
a flexible sprayer hose fluidly coupled to the sprayer outlet;
a nozzle with a first end fluidly coupled to the flexible sprayer hose and a second end pointed out the spray aperture; and
a spray movement assembly operably attached to the spray assembly, the spray movement assembly comprising:
a sprayer frame attached to the spray assembly; and
a movement device operably coupled to the sprayer frame.

2. The attachment of claim 1, wherein the spray aperture is elongated.

3. The attachment of claim 1, wherein the spray movement assembly moves the nozzle across an arc of approximately 30 degrees.

4. The attachment of claim 1, wherein the spray movement assembly further comprises a hydraulic cylinder.

5. The attachment of claim 4, wherein the hydraulic cylinder has a first end fixedly connected to the housing, and a second end fixedly connected to the sprayer frame.

6. The attachment of claim 4, wherein the hydraulic cylinder further comprises a first hose and a second hose, the hoses configured to attach to the adjustable height vehicle to allow control of the nozzle from the cab of the adjustable height vehicle.

7. The attachment of claim 1, wherein the sprayer frame further comprises a pair of wheels.

8. The attachment of claim 7, wherein the wheels roll along a support table within the housing.

9. The attachment of claim 1, wherein the housing further comprises a first channel and a second channel.

10. The attachment of claim 9, wherein the first and second channels are configured to accept the fork arms of a forklift.

11. The attachment of claim 1, further comprising a securing chain attached to the housing, the chain configured to substantially eliminate relative movement between the attachment and the adjustable height vehicle.

12. The attachment of claim 1, wherein the water inlet is configured to attach to a standard fire suppressant water outlet.

13. A water spraying attachment comprising:
a housing;
a water attachment;
a spray aperture on a front wall of the housing;
a water inlet;
a pipe connected to the water inlet and having a sprayer outlet;
a flexible sprayer hose fluidly coupled to the sprayer outlet;
a nozzle with a first end fluidly coupled to the flexible sprayer hose and a second end extending through the spray aperture;
a sprayer frame operably coupled to the nozzle; and
a hydraulic cylinder operably coupled between the housing and the sprayer frame.

14. The attachment of claim 13, wherein the hydraulic cylinder further comprises a first hose and a second hose, the hoses configured to attach to the adjustable height vehicle to allow control of the nozzle from a cab of the adjustable height vehicle.

15. The attachment of claim 13, wherein the housing further comprises a first gusset and a second gusset.

16. The attachment of claim 15, wherein the first and second gussets are configured to accept the fork arms of a forklift.

17. The attachment of claim 13, wherein the sprayer frame further comprises a pair of wheels.

18. The attachment of claim 17, wherein the wheels roll along a support table within the housing.

19. The attachment of claim 13, further comprising a securing chain attached to the housing, the chain configured to substantially eliminate relative movement between the attachment and the adjustable height vehicle.

20. The attachment of claim 13, wherein the water inlet is configured to attach to a standard fire suppressant water outlet.
